(19) United States
(12) Patent Application Publication
(10) Pub. No.: US 2010/0052378 A1
(43) Pub. Date: Mar. 4, 2010

(54) SEAT ASSEMBLY FOR A VEHICLE

(75) Inventors: Brandon S. Marriott, Waterford, MI (US); Bradley M. Glance, Dexter, MI (US)

Correspondence Address: HOWARD & HOWARD ATTORNEYS PLLC, 450 West Fourth Street, Royal Oak, MI, 48067, US

(73) Assignee: SYNTEC SEATING SOLUTIONS, LLC., Sterling Heights, MI (US)

(21) Appl. No.: 12/551,252

(22) Filed: Aug. 31, 2009

Related U.S. Application Data
(60) Provisional application No. 61/093,021, filed on Aug. 29, 2008.

(51) Int. Cl. B60N 2/427; B60N 2/44; B60N 2/68; B60N 2/24

(52) U.S. Cl. 297/216.1; 297/452.18

(57) ABSTRACT

A seat assembly for a bus includes a seat bottom and a seat back pivotally coupled to the seat bottom. An energy absorbing link extends from the seat bottom to the seat back for controlling pivoting of the seat back relative to the seat bottom. The energy absorbing link has a first portion connected to the seat bottom, a second portion connected to the seat back, and a deformable portion disposed therebetween. The deformable portion is deformed as the seat back pivots relative to the seat bottom to absorb energy. First and second members are fixed relative to the energy absorbing link. The first and second members are spaced from each other when the seat back is in an upright position and abut each other when the seat back rotates to a rearward position to limit the deformation of the deformable portion and prevent pivoting beyond the rearward position.

### CROSS-REFERENCE TO RELATED APPLICATIONS

The subject patent application claims priority to and all the benefits of U.S. Provisional Patent Application Ser. No. 61/093,021 which was filed on Aug. 29, 2008, the entire specification of which is expressly incorporated herein by reference.

### BACKGROUND OF THE INVENTION

1. Field of the Invention

The subject invention generally relates to a seat for a vehicle, and more specifically to a seat having a plurality of seat belts.

2. Description of the Prior Art

School buses include a seat assembly for transporting passengers and, more specifically, school buses incorporate several seat assemblies into the school bus in rows. The seat assembly includes a seat bottom extending generally horizontally and a seat back coupled to the seat bottom and extending generally vertically relative to the seat bottom. Typically, the passengers are free to move about the school bus without being restrained in the seat assembly. In other words, the passengers are not buckled into seatbelts to restrain movement of the passengers.

When a bus not equipped with seatbelts is abruptly stopped, such as during a collision, unbelted occupants typically uncontrollably move forward under their own momentum. Current safety requirements, e.g., FMVSS 222, require that the seat back collapses, i.e., rotates forward, and absorbs energy from the occupant during the collapse to reduce the force of impact between the occupant and the seat back. For this reason, in the prior art seat assemblies that do not include seatbelts, the seat back typically folds forward when the occupant uncontrollably moves forward and hits the seat back such that the seat assembly absorbs energy from the uncontrollably moving occupant. Such an arrangement is referred to in industry as compartmentalized seating.

Recently a longstanding debate as to whether school buses should be equipped with seatbelts has intensified and, as a result, more and more school buses are now being equipped with seatbelt assemblies. Public pressure is building to require all school buses be equipped with seatbelt assemblies. A strong consensus has already developed requiring the seatbelt assemblies include a lap/shoulder belt combination similar to designs now installed in most modern automobiles.

In a vehicle, a seatbelt assembly that is mounted to the seat back and the seat back remains stationary relative to the vehicle in order for the seatbelt to properly lock and restrain the passenger. However, in such a configuration, the benefits of the compartmentalized seating required by FMVSS 222 for school buses are lost, i.e., the seat back does not controllably collapse to absorb energy when a passenger strikes the seat back. Because school buses are often used to transport children, it is foreseeable that in a school bus equipped with seatbelt assemblies that some children will buckle their seatbelts while some other children will forget or refuse to buckle their seatbelts.

Accordingly, it would be advantageous to develop a seat assembly that absorbs energy when unbuckled passengers uncontrollably move forward and strike a seat back while also providing adequate support for the seatbelt assembly such that the seatbelt assembly properly functions when the passenger is buckled into the seatbelt.

### SUMMARY OF THE INVENTION AND ADVANTAGES

The present invention includes a seat assembly for a bus. The seat comprises a seat bottom and a seat back pivotally coupled to the seat bottom. An energy absorbing link extends along a longitudinal axis from the seat bottom to the seat back for controlling pivoting of the seat back relative to the seat bottom. The energy absorbing link has a first portion connected to the seat bottom, a second portion connected to the seat back, and a deformable portion disposed between the first and second portions wherein pivoting of the seat back relative to the seat bottom moves the first and second portions relative to each other and deforms the deformable portion. A first member is fixed relative to the first portion and a second member is fixed relative to the second portion with the first and second members spaced from each other when the seat back is in an upright position. The first and second members oppose each other along the longitudinal axis and abut each other when the first and second portions move toward each other for limiting the deformation of the deformable portion to limit the pivoting of the seat back relative to the seat bottom.

The present invention also includes a seat assembly for a bus. The seat assembly comprises a seat bottom and a seat back pivotally coupled to the seat bottom. An energy absorbing link extends along a longitudinal axis from the seat bottom to the seat back for controlling pivoting of the seat back relative to the seat bottom. The energy absorbing link has a deformable portion that deforms when the seat back pivots relative to the seat bottom for absorbing energy as the seat back pivots relative to the seat bottom. A first member is fixed relative to the energy absorbing link and a second member opposes the first member along the longitudinal axis with the first and second members abutting each other when the deformable portion deforms for limiting deformation of the deformable portion to limit pivoting of the seat back relative to the seat bottom.

The present invention also includes seat assembly for a bus. The seat assembly comprises a frame having at least one support member extending in a horizontal plane. A seat pan is supported by the support member above the horizontal plane for supporting a seated occupant. A clip extends downwardly from the seat pan and is moveable between an engaged position engaging the support member for attaching the seat pan to the support member and a disengaged position disengaged from the support member for selectively removing the seat pan from the frame. The support member defines a hole in the horizontal plane and the clip extends into the hole transversely to the horizontal plane when the clip is moved toward the engaged position such that the weight of the occupant on the seat pan urges the clip toward the engaged position to ensure attachment of the seat pan to the support member when the occupant is seated on the seat pan.

The energy absorbing link advantageously controls pivoting of the seat back relative to the seat bottom. When no loads are applied to the seat back, the energy absorbing link maintains the seat back in an upright position. The seat back can rotate from the upright position to the forward position to absorb energy from an occupant who uncontrollably moves forward and strikes the seat back from behind. The seat back can also rotate from the upright position to a rearward position to absorb energy from an occupant who moves into the seat assembly in which the occupant is seated during a rear-end collision or during rebound after a frontal collision.

When the seat back rotates relative to the seat bottom, the deformable portion deforms. This deformation of the deformable portion dampens the rotation between the seat back and the seat bottom to absorb energy from the occupant when the seat back moves toward the forward or rearward positions. Further, when the seat back rotates to the rearward position, the first and second members abut each other and prevent further relative movement between the first and second portions so that the seat back does not rotate beyond the rearward position.

In addition, the configuration of the clips on the seat pan allows for quick and easy assembly and disassembly of the seat pan from the frame without the need for tools. In addition, because the clip extends into the hole transversely to the horizontal plane when the clip is moved toward the engaged position, a downward vertical force forces the clip into engagement with the hole. As such, the weight of the occupant on the seat pan urges the clip toward the engaged position. This configuration ensures attachment of the seat pan to the support member when the occupant is seated on the seat pan.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of several seat assemblies mounted in rows to a floor of a vehicle;

FIG. 2 is a perspective view of a seat assembly including a seat bottom and a seat back;

FIG. 3 is a perspective view of a portion of the seat assembly with some components removed to illustrate interior components;

FIG. 4 is another perspective view of a portion of the seat assembly with additional components removed to illustrate other interior components;

FIG. 5 is a perspective fragmented view of a portion of the seat assembly with a seat pan exploded away from a bottom frame;

FIG. 6 is a fragmented cross-sectional view of the seat pan connected to the bottom frame through line 6-6 of FIG. 3;

FIG. 7 is a front view of the seat assembly configured in a two passenger configuration;

FIG. 8 is a front view of the seat assembly configured in a three passenger configuration;

FIG. 9 is a perspective view of an energy absorbing link;

FIG. 10 is a side view of the energy absorbing link of FIG. 9;

FIG. 11 is a perspective view of another embodiment of the energy absorbing link;

FIG. 12 is perspective view of another embodiment of the energy absorbing link;

FIG. 13 is a cross-sectional view of the seat assembly along line C-C of FIG. 3 when the seat back is in an upright position;

FIG. 14 is a cross-sectional view of the seat assembly along line C-C of FIG. 3 when the seat back is in a forward position;

FIG. 15 is a cross-sectional view of the seat assembly along line C-C of FIG. 3 when the seat back is in a rearward position;

FIG. 16 is a perspective view of the seat assembly in a shipping configuration; and

FIG. 17 is a side view of several seat assemblies disposed in the shipping configuration and stacked upon each other.

### DETAILED DESCRIPTION OF THE INVENTION

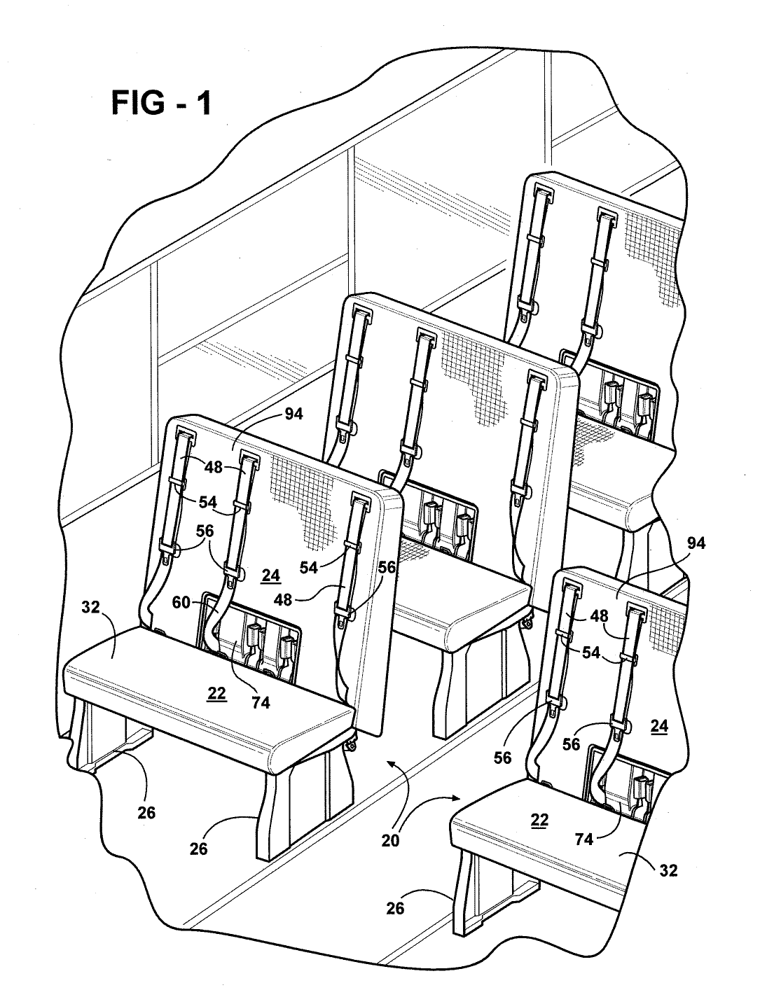

Referring to the Figures, wherein like numerals indicate corresponding parts throughout the several views, a seat assembly 20 is generally shown at 20. As shown in FIG. 1, the seat assembly 20 is typically disposed in a vehicle such as, for example, a standard school bus. Accordingly, as is known in the art, several seat assemblies 20 can be incorporated into the school bus in rows. It should be appreciated that the seat assembly 20 may be used in any type of vehicle including, for example, an automobile, an airplane, or a boat.

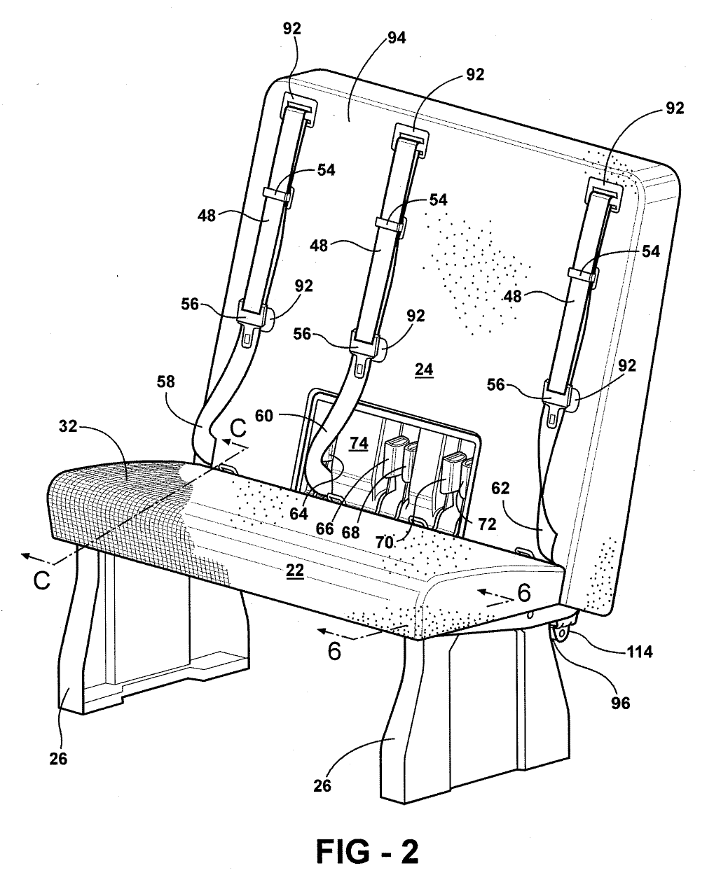

With reference to FIG. 2, the seat assembly 20 includes a seat bottom 22 extending generally horizontally and a seat back 24 extending generally vertically from the seat bottom 22. As described further below, the seat back 24 is pivotally coupled to the seat bottom 22. The seat assembly 20 typically includes mounting pedestals 26 attached to and extending downwardly from the seat bottom 22. The mounting pedestals 26 are typically mounted to a floor of the vehicle, as shown in FIG. 1. It should be appreciated that the seat assembly 20 may be coupled directly to a wall of the vehicle without departing from the nature of the present invention.

The seat bottom 22 typically includes a bottom frame 28 formed of metal. However, it should be understood that the bottom frame 28 can be constructed from other materials not described herein that are capable of providing the necessary support and strength.

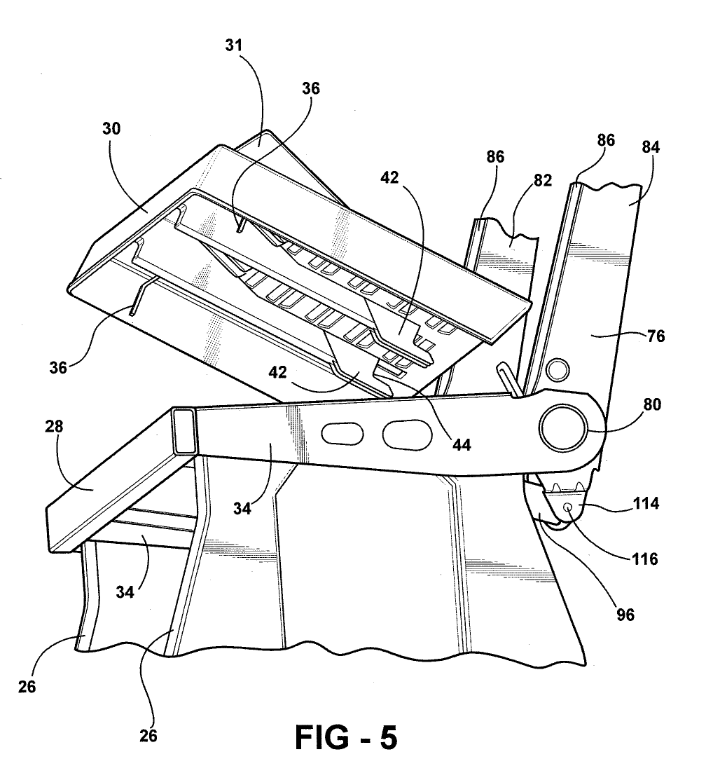

As best shown in FIG. 5, a seat pan 30 is typically disposed on the bottom frame 28. The seat pan 30 is, for example, formed by injection molding. However, it should be appreciated that the seat pan 30 can be formed from any material and by any method, such as, but not limited to blow molding or thermoforming without departing from the nature of the present invention. Alternatively, the seat pan 30 can be formed of plywood covered with foam and upholstery.

The seat pan 30 may include a ramp 31 along a front edge for urging occupants of the seat assembly 20 toward the seat back 24 and to reduce the likelihood that the occupant slides relative to the lap portion of a seatbelt when the vehicle is stopped abruptly resulting in improper occupant restraint as the lap portion of the seatbelt bears on softer abdominal tissue instead of the pelvic bone of the occupant, which is typically referred to in industry as “submarining.”

Seat upholstery 32 can be attached to the seat pan 30. For example, the seat upholstery 32 includes fabric and J-clips attached to the fabric. In such a configuration, the J-clips attach to the seat pan 30 without the need for secondary fasteners. As such, the seat upholstery 32 is removable from the seat pan 30 by disconnecting the J-clips from the seat pan 30 such that the seat upholstery 32 can be easily removed for cleaning, repair, or replacement. Alternatively, the J-clips could attach to themselves, i.e., mating pairs, if the seat upholstery 32 is wrapped around the back panel 78, and the J-clips can connect directly to the seat pan 30 to fasten the seat upholstery 32 the seat cushion. As set forth above, the ramp 31 can be defined by the seat pan 30. Alternatively, the ramp 31 can be formed by disposing a separate element (not shown) between the seat pan 30 and the seat upholstery 32 without departing from the nature of the present invention.

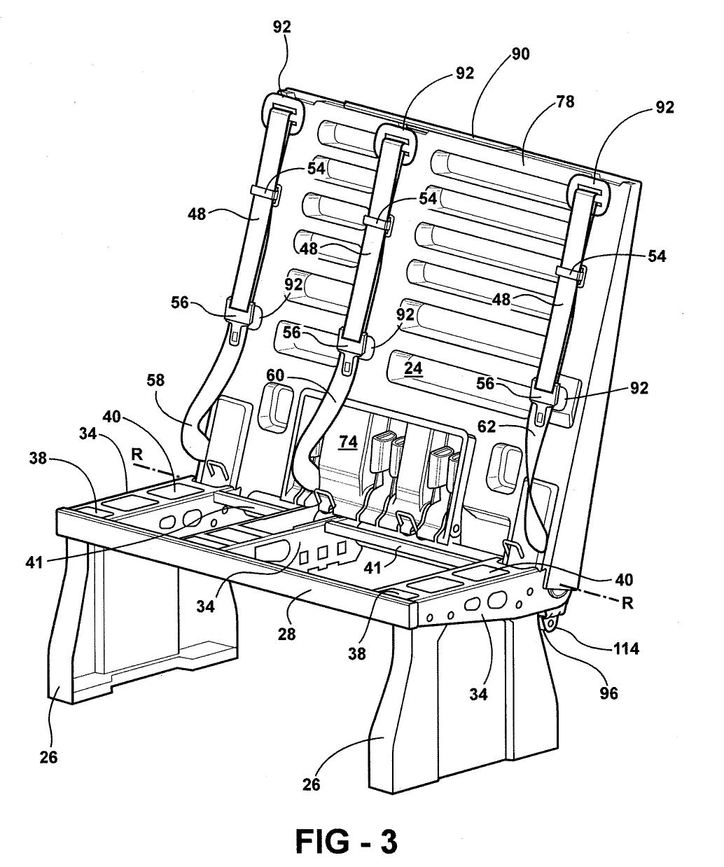

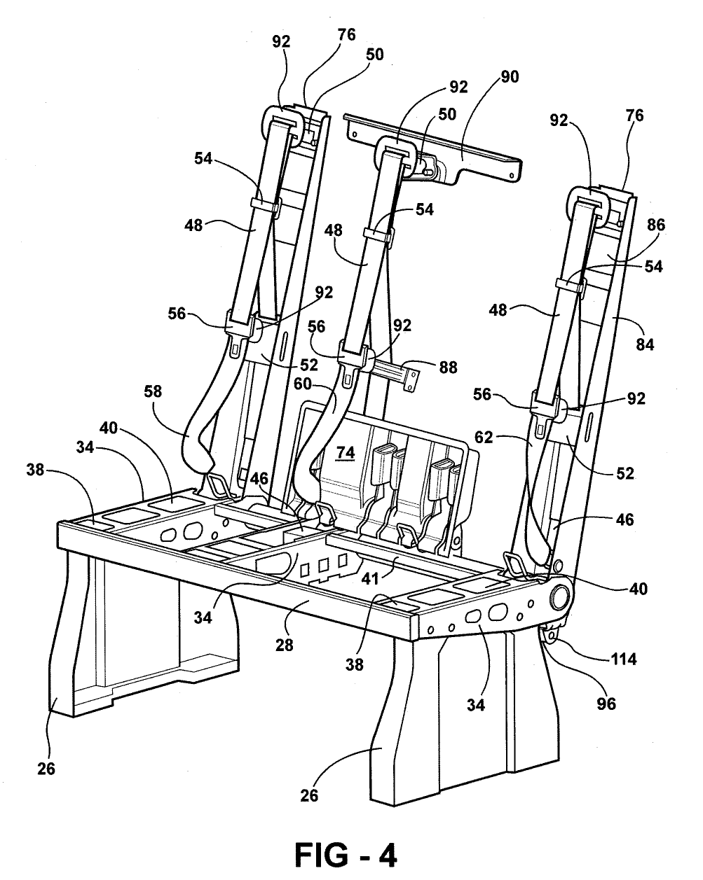

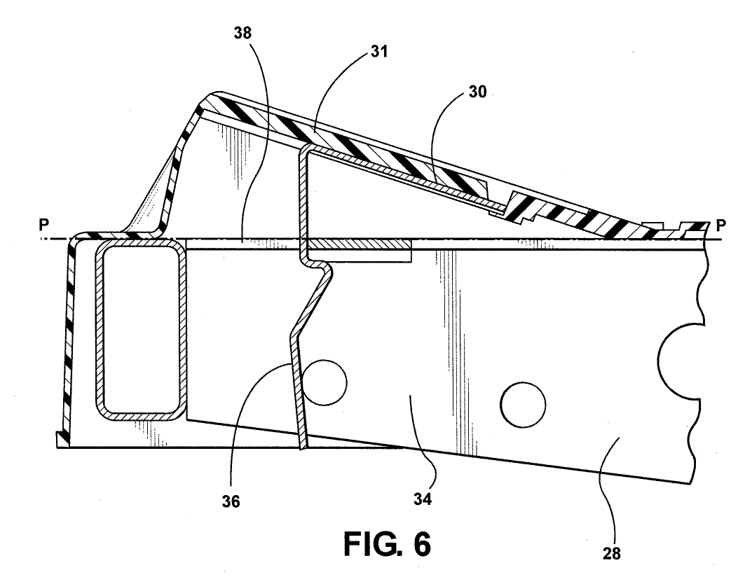

The bottom frame 28 has at least one support member 34 extending in a horizontal plane P. As best shown in FIGS. 3 and 4, the bottom frame 28 typically includes three support members 34. The seat pan 30 is supported by the support member 34 above the horizontal plane P for supporting the seated occupant. It should be appreciated that the horizontal plane P is the plane that extends through the top surface of each support members 34, i.e., the top surface that contacts and supports the seat pan 30 as shown in FIG. 6. It should also be appreciated that the horizontal plane P need not be exactly horizontal but merely has a horizontal component that is sufficient such that the occupant is supported by the bottom frame 28.

With reference to FIGS. 5 and 6, at least one clip 36 extends downwardly from the seat pan 30 to connect the seat pan 30 to the bottom frame 28. The clip 36 is moveable between an engaged position engaging the support member 34 for attaching the seat pan 30 to the support member 34 and a disengaged position disengaged from the support member 34 for selectively removing the seat pan 30 from the bottom frame 28.

Specifically, the support member 34 defines a hole 38 in the horizontal plane P, shown in FIGS. 3 and 4, and the clip 36 extends into the hole 38 transversely to the horizontal plane P when the clip 36 is moved toward the engaged position, as shown in FIG. 6. As such, a downward vertical force applied to the seat pan 30, such as the weight of the occupant on the seat pan 30, urges the clip 36 toward the engaged position. This configuration ensures attachment of the seat pan 30 to the support member 34 when the occupant is seated on the seat pan 30. Typically, the clip 36 is disposed on the seat pan 30 and the hole 38 is defined in the support member 34. Alternatively, the clip 36 can be on the support member 34 and the hole 38 can be defined in the seat pan 30 without departing from the nature of the present invention. The seat assembly 20 includes two clips 36 and two holes in the Figures; however, it should be appreciated that the seat assembly 20 can include any number of clips 36 and corresponding holes 38 without departing from the nature of the present invention.

The seat pan 30 includes a finger 42 engaging the bottom frame 28 to attach the seat pan 30 to the bottom frame 28. The seat pan 30 includes two fingers 42 in the Figures; however, it should be appreciated that the seat pan 30 can include any number of fingers 42 and corresponding without departing from the nature of the present invention.

In the embodiment shown in the Figures, the bottom frame 28 includes a cross-bar 41 extending along a rear of the bottom frame 28. The fingers 42 slide under the cross-bar 41 to engage the seat pan 30 to the bottom frame 28. It should be appreciated that the bottom frame 28 can include more than one cross-bar 41 for engaging the fingers 42 without departing from the nature of the present invention.

In an alternative embodiment, the support member 34 defines a second hole 40 spaced from the hole 38. The finger 42 extends from the seat pan 30 into the second hole 40 and engages the support member 34 in the second hole 40 to attach the seat pan 30 to the support member 34. It should be appreciated that the seat assembly 20 can include any number of second holes 40 corresponding to the number of fingers 42 without departing from the nature of the present invention.

The seat pan 30 is connected to the bottom frame 28 by first engaging the fingers 42 with the bottom frame 28, e.g., inserting the fingers 42 into engagement with the cross-bar 41. When inserted into the second holes 40, the fingers 42 extend below the horizontal plane P of the support member 34 with the cross-bar 41 pinched between the fingers 42 and another portion of the seat pan 30. The seat pan 30 is then slid toward the seat back 24 along the horizontal plane P to firmly seat the fingers 42 against the cross-bar 41. The fingers 42 include a stop surface 44 that abuts the cross-bar 41 to ensure proper location of the seat pan 30 relative to the support member 34, i.e., the seat pan 30 is properly located relative to the bottom frame 28 when the stop surface 44 abuts the cross-bar 41.

When the seat pan 30 is properly located relative to the bottom frame 28, the clips 36 are aligned with the holes 38 in the support member 34. Once the seat pan 30 is properly located relative to the bottom frame 28, a downward force is exerted on the seat pan 30 to engage the clips 36 with the holes 38. Notably, the clip 36 is moveable to the engaged position only when the finger 42 is engaged with the second hole 40.

To remove the seat pan 30 from the bottom frame 28, the clips 36 are biased away from the holes 38 in the support member 34 to allow the clips 36 to pass through the holes 38 such that the fingers 42 can be removed from the cross-bar 41. The configuration allows for easy installation and removal of the seat pan 30 while ensuring a reliable connection between the seat pan 30 and the bottom frame 28. The seat pan 30 can be installed to and removed from the bottom frame 28 without the use of tools. Accordingly, the seat pan 30 can be easily removed for repair or replacement without complicated disassembly.

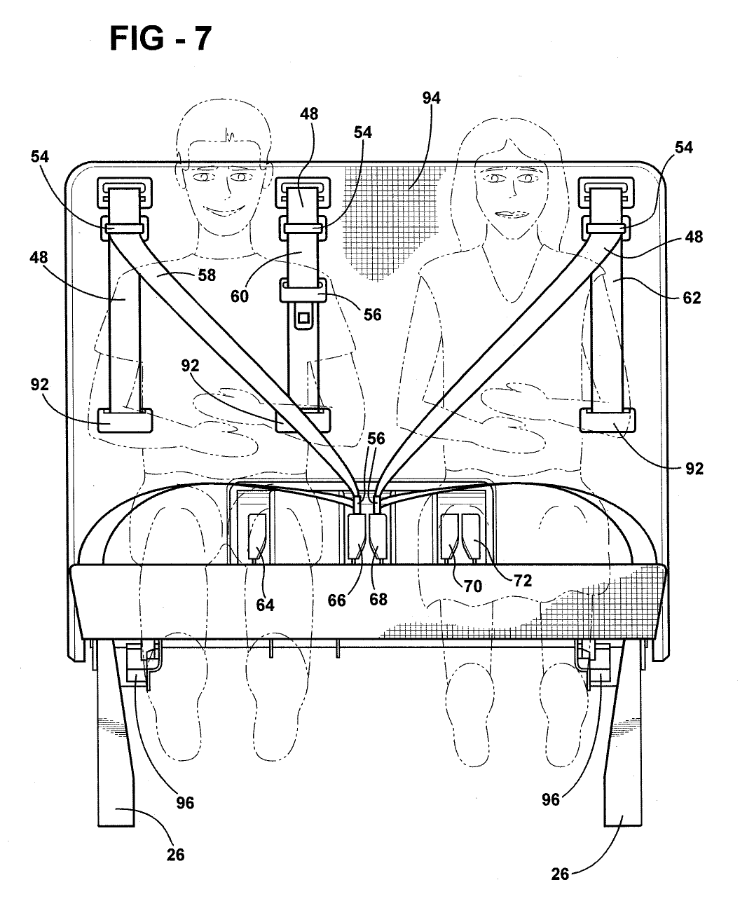

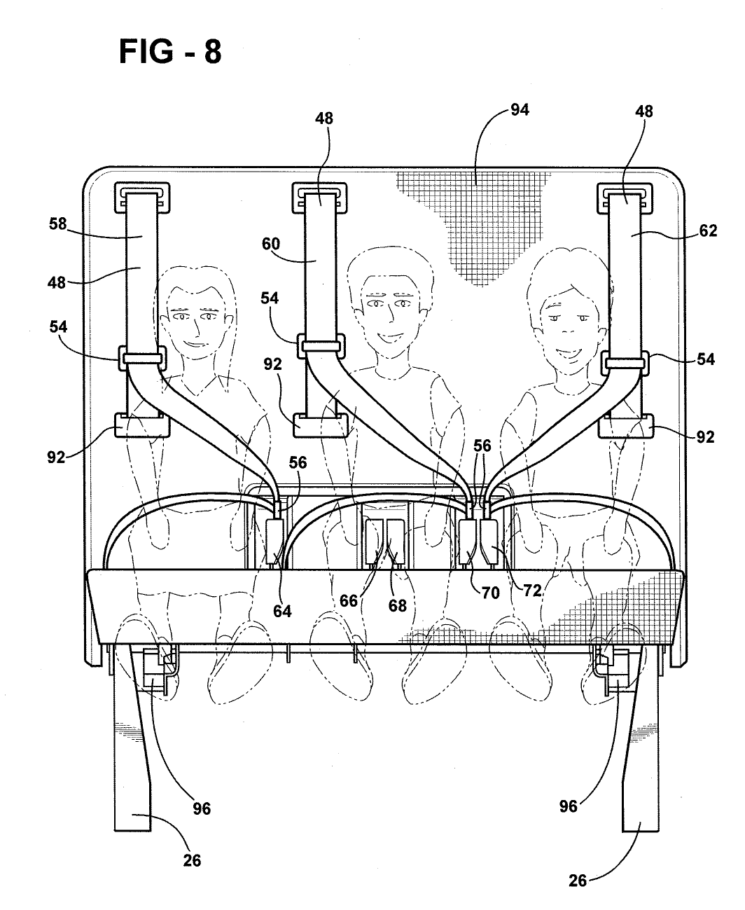

The seat assembly 20 includes a plurality of seatbelts and corresponding hardware configurable for use by either two larger occupants in a two occupant configuration, as shown in FIG. 7, or three smaller occupants in a three occupant configuration, as shown in FIG. 8. The seatbelts and the corresponding hardware can be that which are known in industry. Accordingly, the seatbelts and the seatbelt hardware are not described in detail herein. Additionally, methods of attaching the hardware to the support frame are also well known and are not described in detail herein. The hardware, for example, includes such items as a retractor 46, a belt 48, i.e., webbing, extendable from the retractor 46, a shoulder retainer 50, and a middle retainer 52 for receiving the belt 48 to anchor the belt 48 to the seat back 24, a belt height adjuster 54, also referred to in industry as an webbing adjuster, coupled to the belt 48, and a latch plate 56 coupled to the belt 48. The belt height adjuster is moved up and down along the belt 48 depending on the shoulder height of the occupant seated in the seat assembly 20 in order to position the torso webbing across the clavicle of each properly seated occupant.

The seat assembly 20 includes a first seatbelt 58, a second seatbelt 60, and a third seatbelt 62. The first seatbelt 58 is coupled to the seat back 24. The second seatbelt 60 is coupled to the bottom frame 28, as shown in FIG. 4. The third seatbelt 62 is coupled to the seat back 24.

Referring to FIG. 2, moving along a rear edge, i.e., the bight line, of the seat back 24 along a direction from a left side to a right side of the seat back 24, the first seatbelt 58 is disposed at the left side. The second seatbelt 60 is disposed at approximately ⅓ of the distance from the left side to the right side. The third seatbelt 62 is disposed at the right side.

The seat assembly 20 includes a plurality of buckles for receiving the latch plates 56 of the first 58, second 60, and third 62 seatbelts, respectively. Specifically, the seat assembly includes a first buckle 64, a second buckle 66, a third buckle 68, a fourth buckle 70, and a fifth buckle 72. With reference to FIG. 2, moving along the rear edge of the seat back 24 along the distance from the left side to the right side of the seat back 24, the first buckle 64 is disposed at approximately ⅓ of the distance from the left side to the right side. The second 66 and third 68 buckles are disposed at approximately ½ of the distance from the left side to the right side. The fourth 70 and fifth 72 buckles are disposed at approximately ⅔ of the distance from the left side to the right side. As best shown in FIG. 4, a tray 74 is typically disposed in the seat back 24 to house the buckles.

Typically, the second 66 and third 68 buckles and the fourth 70 and fifth 72 buckles are disposed adjacent each other. Alternatively, the second 66 and third 68 buckles can integrally extend from each other and the fourth 70 and the fifth 72 buckles can integrally extend from each other.

When the seat assembly 20 is utilized for seating the two larger occupants, as shown in FIG. 7, the latch plate 56 of the first seatbelt 58 locks into the second buckle 66 and the latch plate 56 of the third seatbelt 62 locks into the third buckle 68. Alternatively, when the seat assembly 20 is utilized for seating the three smaller occupants, as shown in FIG. 8, the latch plate 56 of the first seatbelt 58 locks into the first buckle 64, the latch plate 56 of the second seatbelt 60 locks into the fourth buckle 70, and the latch plate 56 of the third seatbelt 62 locks into the fifth buckle 72.

Accordingly, the first 64, fourth 70, and fifth 72 buckles are not utilized in the two occupant configuration. Likewise, the second 66 and third 68 buckles are not utilized in the three occupant configuration. Therefore, if one does not want the versatility of switching between the two occupant configuration and the three occupant configuration, and only wishes to provide seating for the two occupant configuration, then the first 64, fourth 70, and fifth 72 buckles, may be omitted from the seat assembly 20 to save money. Likewise, if one only wishes to provide seating for the three occupant configuration, then the second 66 and third 68 buckles may be omitted from the seat assembly 20 to save money.

The latch plates 56 on the seatbelts and the buckles are preferably visually coded and/or keyed to assist the occupants in properly pairing the latch plates 56 and the buckles for the two occupant configuration or the three occupant configuration. Specifically, with respect to visual coding, the latch plate 56 on the second seatbelt 60 is visually coded similarly to the fourth buckle 70 to indicate to occupants that the latch plate 56 on the second seatbelt 60 corresponds to the fourth buckle 70. For example, the visual coding includes color coding such that corresponding latch plates 56 and buckles are similarly colored. Another example of visual coding includes text printed on or imbedded on the latch plates 56 and buckles. Likewise, with respect to keying, the latch plate 56 on the second seatbelt 60 is keyed similarly to the fourth buckle 70 so that the latch plate 56 on the second seatbelt 60 can only engage the fourth buckle 70.

With reference to FIGS. 2-4, the seat back 24 includes a back frame 76 and a back panel 78 disposed over the back frame 76. The back panel 78 will be discussed in further detail below. The back frame 76 is preferably formed of a metal, such as steel or aluminum. However, it should be understood that the back frame 76 may be constructed from other materials not described herein that are capable of providing the necessary support and strength. The seat back 24 may include foam pillows or other cushioning material (not shown) positioned to absorb energy from an occupant who uncontrollably strikes the seat back 24 in front of the occupant when the vehicle is accelerated abruptly.

As shown in FIG. 4, the seat assembly 20 includes a tubular rear cross member 80 and the back frame 76 includes a first tower 82 and a second tower 84, each extending generally upwardly from the tubular rear cross member 80. Typically, the tubular rear cross member 80 has a round cross-section and both of the first 82 and the second 84 towers defines a round hole receiving the tubular rear cross member 80. The tubular rear cross member 80 and the round holes are sized such that the towers 82, 84 are rotatable about the tubular rear cross member 80.

The back panel 78 structurally reinforces the towers 82, 84 of the seat back 24. In other words, the back panel 78 ties together the towers 82, 84 and creates a structure for the seat back 24. The back panel 78 is typically formed by blow molding. However, it should be appreciated that the back panel 78 can be formed from any material and by any method, such as, but not limited to plastic injection molding, thermoforming, metal stamping welded to the back frame 76, etc. without departing from the nature of the present invention.

The back panel 78 is typically hollow and receives each of the towers 82, 84. Typically the back panel 78 has a back portion presenting a concaved configuration for increasing a space between the back panel 78 and a subsequent row. It should be appreciated that there are requirements for spacing between rows of seat assemblies 20 on school buses. It is advantageous to provide a seat assembly 20 with a concaved seat back 24 such that the concaved seat back 24 provides additional spacing which allows for the installation of the maximum number of rows of seat assemblies 20 in a school bus by efficiently designing the seat back 24 to be of the minimum thickness necessary to meet the performance requirement.

With reference to FIG. 4, both of the towers 82, 84 define a channel 86, i.e., both of the towers 82, 84 are generally U-shaped. The retractors 46 of the first 58 and third 62 seatbelts are disposed in the channel 86 of the first 82 and the second 84 towers, respectively, and are connected to the first 82 and second 84 towers, respectively. As such, the belt extends upwardly from the retractor 46 within the channel 86 and then from the middle retainer 52 to the shoulder retainer 50 along the outside of the back panel 78. Typically, the middle retainer 52 is coupled along the tower 82, 84 and the shoulder retainer 50 is coupled near an end of the tower 82, 84 opposite the support member 34. It is to be appreciated that the positioning of the middle retainer 52 and the shoulder retainer 50 may vary without departing from the nature of the present invention.

The retractor 46 of the second seatbelt 60 is connected to the middle support member 34. A web guide 88 for the second seatbelt 60 is coupled to the back panel 78 for allowing the second seatbelt 60 to pass through the back panel 78. A reinforcing bracket 90 is attached to a back side of the back panel 78 for supporting the shoulder retainer 50 for the second seatbelt 60. The shoulder retainer 50 and the web guide 88 for the second seatbelt 60 are each configured to guide the belt 48 inside the channels 86 under the back panel 78 so that the belt 48 can pass through back panel 78 at bezels 92 adjacent the middle retainer 52.

The tubular rear cross member 80 defines a depression for allowing the second seatbelt 60 to wrap around the tubular rear cross member 80 and into the back panel 78. The second seatbelt 60 then continues to the shoulder retainer 50, in a similar fashion as the first 58 and third 62 seatbelts, and then out through the bezel 92.

The configuration of the seatbelts strung between the middle retainer 52 and the shoulder retainer 50 advantageously reduces or eliminates lateral forces, i.e., twisting of the seat back 24, when the seatbelt is activated to retain an occupant. In other words, the belt 48 of the seatbelt exerts only a bending force on the tower 82, 84 and does not twist the tower 82, 84. As such, material that increases the resistance of the towers 82, 84 to twisting can be reduced, which is advantageous with respect to cost to manufacture and packaging.

Back upholstery 94 can be attached to the back panel 78. For example, the back upholstery 94 includes fabric and J-clips attached to the fabric. As with the seat upholstery 32 on the seat bottom 22, the J-clips attach to the back panel 78 of the seat back 24 or to each other, i.e., interlocking J-clips. As such, the back upholstery 94 is removable from the seat back 24 by disconnecting the J-clips from the back panel 78.

The buckles are spring loaded such that the buckles are biased toward the tray 74. As such, the occupant pulls the buckle out of the tray 74 against the bias of the spring load to lock one of the latch plates 56 into the buckle. When the latch plate 56 is released from the buckle, the spring load biases the buckle toward the tray 74 and the buckle recesses back into the tray 74. As such, the occupants comfortably sit on the seat assembly 20 without uncomfortable contact with any one of the buckles. Specifically, in the two occupant configuration, one of the occupants is seated in front of the first buckle 64 and the other occupant sits in front of the fourth 70 and fifth 72 buckles. In the three occupant configuration, a middle occupant is seated in front of the second 66 and third 68 buckles.

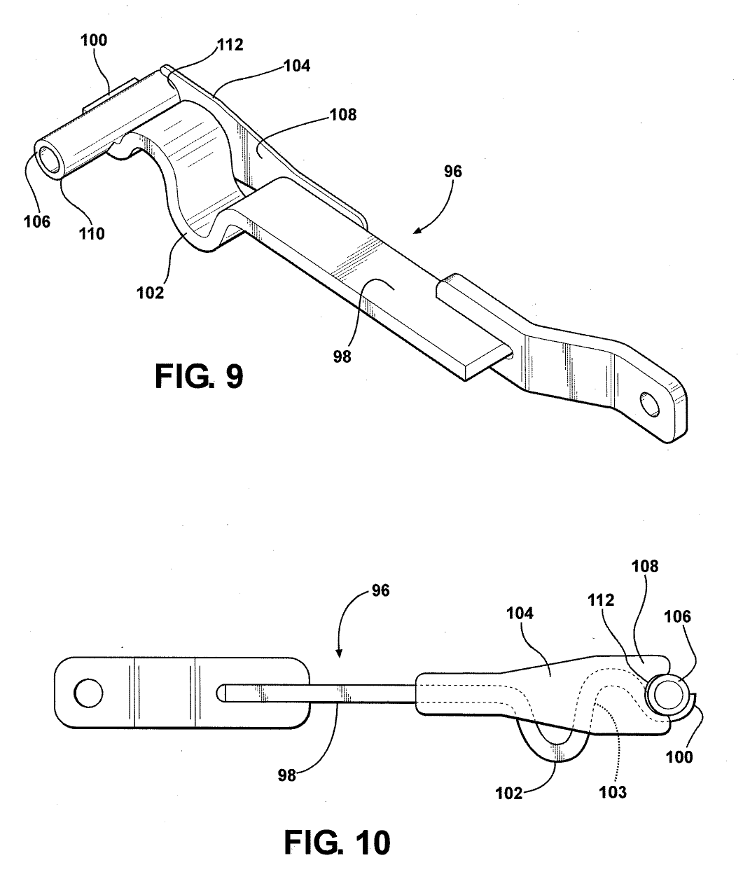

As best shown in FIGS. 9-15, the seat assembly 20 includes at least one energy absorbing link 96 extending along a longitudinal axis L from the bottom frame 28 of the seat bottom 22 to the back frame 76 of the seat back 24. For exemplary purposes, the seat assembly 20 shown in the Figures includes two energy absorbing links 96. However, it should be appreciated that the seat assembly 20 can include any number of energy absorbing links 96 without departing from the nature of the present invention.

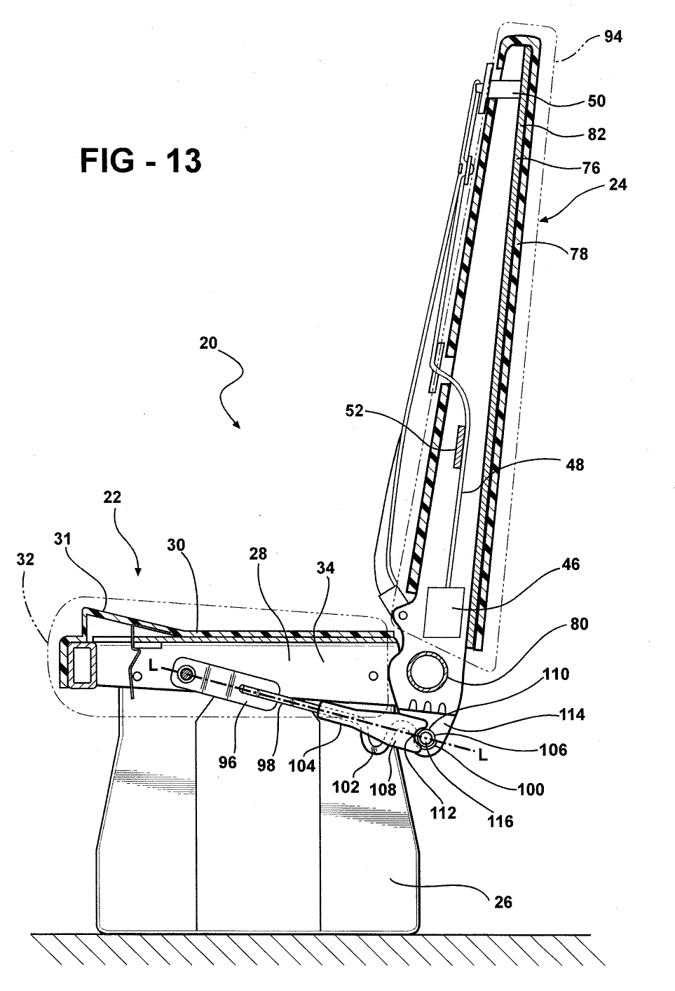

The energy absorbing link 96 controls pivoting of the seat back 24 relative to the seat bottom 22. When no loads are applied to the seat back 24, the energy absorbing link 96 maintains the seat back 24 in an upright position, as shown in FIG. 13, to support the back of occupants seated on the seat assembly 20. Said differently, the energy absorbing link 96 couples the towers 82, 84 of the seat back 24 to the seat bottom 22 for providing rigidity to the seat back 24 in the upright position. It should be appreciated that the “upright position” can also be referred to as the design position because it is a position of the seat back 24 as designed to support the back of occupants during normal use. As such, it should be appreciated that the “upright position” can be vertical or can be angled forwardly or rearwardly from vertical.

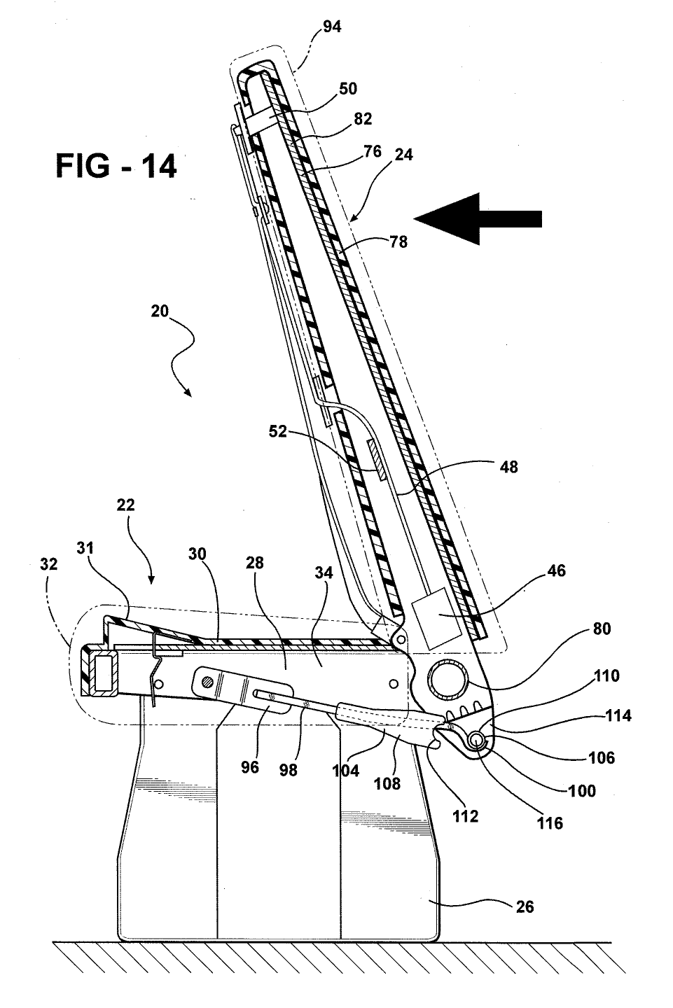

As described further below, the energy absorbing link 96 allows the seat back 24 to rotate relative to the seat bottom 22 when sufficient force is applied to the seat back 24. The seat back 24 can rotate from the upright position to a forward position, for example, to absorb energy from an occupant who uncontrollably moves forward and strikes the seat back 24 in front of the occupant when the vehicle is abruptly stopped. The seat back 24 rotates toward the seat bottom 22 from the upright position to the forward position, as shown in FIG. 14.

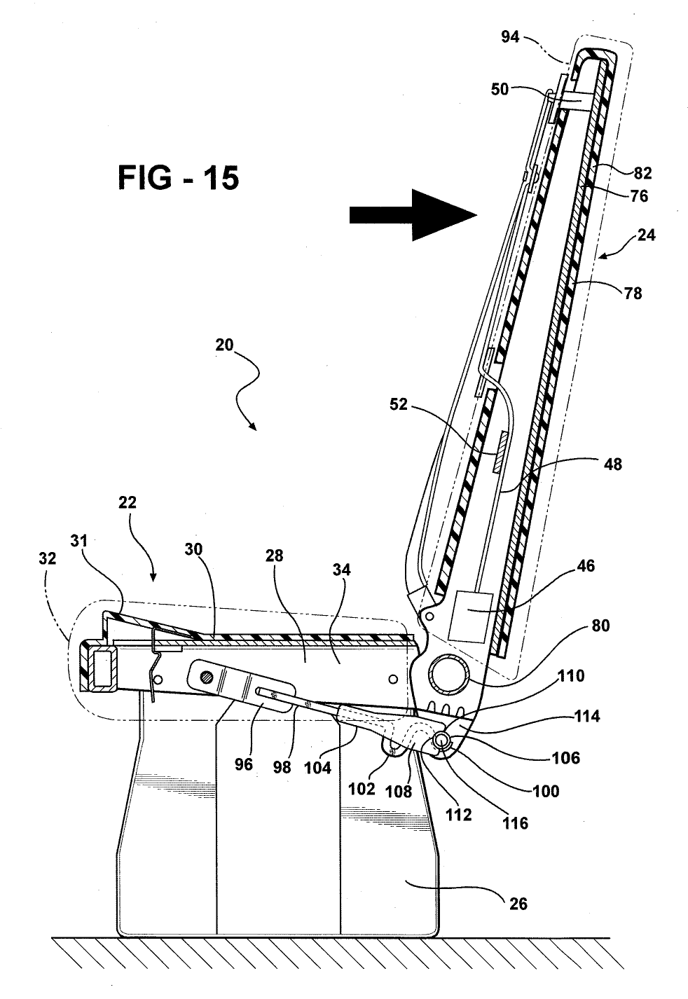

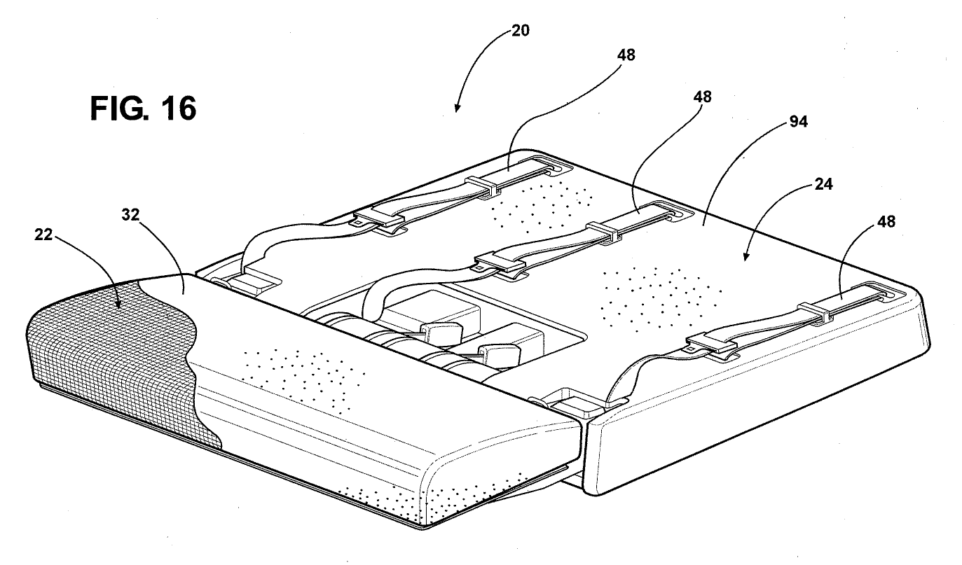

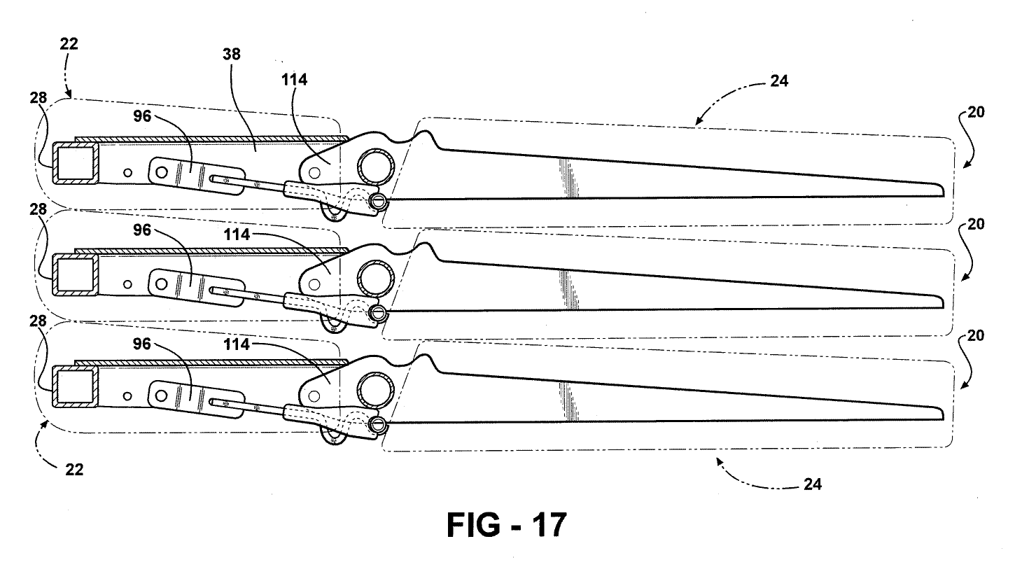

In addition, the seat back 24 can rotate from the upright position to a rearward position, for example, to absorb energy from an occupant who moves into the seat assembly 20 in which the occupant is seated during a rear-end collision or during rebound after a frontal collision. The seat back 24 rotates away from the seat bottom 22 from the upright position to the rearward position, as shown in FIG. 15.

With reference to FIGS. 9-12, the energy absorbing link 96 includes a first portion 98, a second portion 100, and a deformable portion 102 disposed between said first 98 and second 100 portions. The first portion 98, second portion 100, and deformable portion 102 are typically integral with each other, i.e., formed from a single piece of material. Alternatively, the first portion 98, second portion 100, and deformable portion 102 can be formed as individual components that are subsequently connected together to form the energy absorbing link 96.

The deformable portion is further defined as a kink 103 that has a generally U-Shaped configuration. As set forth further below, the kink 103 is compressed to absorb energy as the seat back 24 rotates from the upright position to the rearward position and is stretched to absorb energy as the seat back 24 rotates from the upright position to the forward position. It should be appreciated that the deformable portion 102 can have any sort of geometry capable of deforming to absorb energy as the seat back 24 rotates relative to the seat bottom 22 without departing from the nature of the present invention.

The first 98 and second 100 portions are rigid relative to the deformable portion 102 such that pivoting of the seat back 24 relative to the seat bottom 22 moves the first 98 and second 100 portions relative to each other and deforms the deformable portion 102. This deformation of the deformable portion 102 dampens the rotation between the seat back 24 and the seat bottom 22 to absorb energy from the occupant when the seat back 24 moves toward the forward or rearward positions.

When the seat back 24 rotates away from the seat bottom 22 from the upright position to the rearward position, the first 98 and second 100 portions move toward each other and deform the deformable portion 102, e.g., compress the kink 103, as shown in Figure 15. In the preferred embodiment, when the seat back 24 rotates toward the seat bottom 22 from the upright position to the forward position, the first 98 and second 100 portions move away from each other and deform the deformable portion 102, e.g., straighten the kink 103, as shown in FIG. 14. When sufficient force is applied to the seat back 24, the deformable portion 102 plastically deforms when the first 98 and second 100 portions move toward each other when the seat back 24 moves to the rearward position and when the first 98 and second 100 portions move away from each other when the seat back 24 moves to the forward position.

First 104 and second 106 members oppose each other along the longitudinal axis L of the energy absorbing link 96 to limit the compression of the energy absorbing link 96 when the seat back 24 rotates from the upright position to the rearward position. Typically, as shown in FIGS. 9-11, the first member 104 is fixed relative to and extends from the first portion 98 and the second member 106 is fixed relative to and extends from the second portion 100 such that the first member 104 moves with the first portion 98 and the second member 106 moves with the second portion 100. Alternatively, one of the first 104 and second 106 members can be fixed relative to the seat bottom 22 in such a configuration that the first 104 and second 106 members move toward each other when the first 98 and second 100 portions move toward each other.

As shown in FIG. 13, the first 104 and second 106 members are spaced from each other when the seat back 24 is in an upright position. When the seat back 24 rotates to the rearward position, the first and second members 106 abut each other, as shown in FIG. 15, and prevent further relative movement between the first 98 and second 100 portions for limiting the deformation of the deformable portion 102 to limit the pivoting of the seat back 24 relative to the seat bottom 22.

The first member 104 is further defined as a plate 108 attached to the first portion 98 and extending along the longitudinal axis L toward the second member 106. The second member 106 is further defined as a sleeve 110 attached to the second portion 100 and opposing the plate 108 along the longitudinal axis. The plate 108 defines a cutout 112 receiving the sleeve 110 and abutting the sleeve 110 when the first 98 and second 100 portions move toward each other.

As shown in FIG. 13, the sleeve 110 and the plate 108 are spaced from each other when the seat back 24 is in the upright position. As shown in FIG. 14, when the seat back 24 moves to the rearward position, the first 98 and second 100 portions of the energy absorbing link 96 move toward each other and the deformable portion 102 deforms, e.g., the kink 103 compresses, to absorb energy from the rotating seat back 24. When the seat back 24 reaches the rearward position, the plate 108 contacts the sleeve 110 to prevent further relative movement between the first 98 and second 100 portions. The material construction of the plate 108 can also allows some deformation, if desired, to provide a sequential displacement of the seat back 24.

In the present invention, the seat back 24 of the seat assembly 20 on which the occupant is seated must provide adequate support such that the seatbelt locks and prevents the occupant from flying forward. In other words, the seat back 24 must remain in a generally upright position in order for the seatbelt to properly function and stop the occupant buckled thereto from uncontrollably moving forward. However, some occupants may forget or refuse to use the seatbelt and in a situation involving an abrupt stop, the occupant who is not buckled to with the seatbelt can move forward and strike the seat back 24 of the seat assembly 20 in front of the occupant. Therefore, the seat back 24 of the present invention has some flexibility in order to absorb energy from the unseated occupant, as required by FMVSS 222.

As such, the energy absorbing link 96 is designed to provide such flexibility while also maintaining the seat back 24 in the generally upright position, i.e., the energy absorbing link 96 allows for some rotation of the seat back 24 but also limits the rotation of the seat back 24 to a predetermined rotational angle.

If the occupant uncontrollably moves forward and impacts the seat back 24 of the seat assembly 20 in front of the occupant, the seat back 24 in front of the occupant rotates forward to absorb energy from the occupant, as required by FMVSS 222. In such a situation, the deformable portion 102 deforms, e.g., the kink 102 is straightened, thereby allowing the seat back 24 to rotate relative to the seat bottom 22 and to absorb the occupant's energy. In the embodiment where the deformable portion 102 is defined as the kink 103, when the kink 103 is fully straightened the energy absorbing link 96 prevents further rotation of the seat back 24 relative to the seat bottom 22 such that the seatbelts of the rotating seat assembly 20 may properly function to restrain the belted occupant in the seat assembly 20. As the kink 102 is straightened, the plate 108 moves away from the sleeve 110.

If the occupant moves backward and impacts the seat back 24 of the seat assembly 20 the occupant is sitting in, the plate 108 prevents the seat back 24 from rotating backwards beyond the rearward position and prevents further deformation of the deformable portion 102, e.g., collapse of the kink 103. It is to be appreciated that the space between the compression plate 108 and the coupling tube can be designed to allow the seat back 24 to rotate a predetermined angle, i.e., to the rearward position, until the plate 108 contacts the sleeve 110. The mechanical properties and geometry of the plate 108 can be modified to tune the force-deflection characteristics of the seat back 24 when loaded in this way.

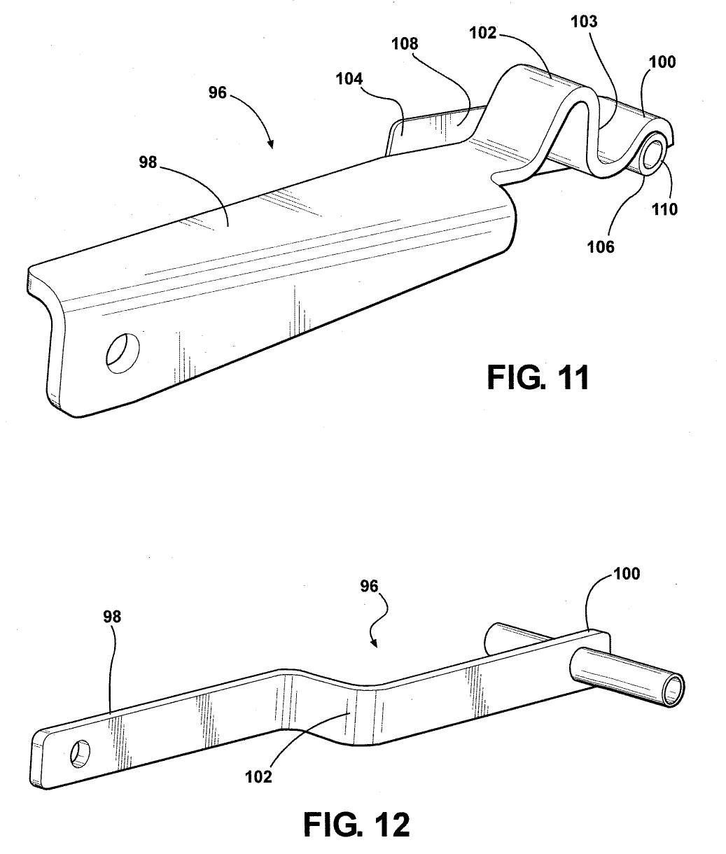

It should to be appreciated that the energy absorbing link 96 can comprise multiple segments, as shown in FIGS. 9 and 10, or may comprise a single integral component or a combination of integrally formed components, as shown in FIG. 11, without departing from the nature of the present invention. It is also to be appreciated that the energy absorbing link 96 may forgo the plate 108, as shown in FIG. 12, with the energy absorbing link 96 designed to resist both the tensile and compression loading. One of the advantages of using the energy absorbing link 96 is that it can be easily configured to meet the testing requirements as the testing requirements vary base on the vehicle the seat assembly 20 will be installed in.

With reference to FIGS. 13-15, the first portion 98 of the energy absorbing link 96 is connected to the bottom frame 28 of the seat bottom 22. The first portion 98 is typically pivotally coupled to the bottom frame 28 such that the first portion 98 can pivot relative to the bottom frame 28. The first portion 98 can be attached to the bottom frame 28, for example, by bolting or pinning the first portion 98 to the bottom frame 28.

The second portion 100 of the energy absorbing link 96 is connected to the back frame 76 of the seat back 24. The seat back 24 pivots about a rotational axis R defined along the tubular rear cross member 80 and presents an extension 114 spaced from the rotational axis R. Specifically, both of the towers 82, 84 present an extension 114 extending generally downwardly beyond the tubular rear cross member 80. Typically, both of the towers 82, 84 include a pair of extensions 114 spaced from each other and extending generally downwardly. A pin 116 extends through the sleeve 110 and engages the extension 114 for connecting the second portion 100 to the seat back 24. In FIGS. 13-15, the first 98 and second 100 portions of the energy absorbing link 96 are connected to the seat bottom 22 and the seat back 24, respectively, for exemplary purposes. Alternatively, the first portion 98 and be connected to the seat back 24 and the second portion 100 can be connected to the seat bottom 22 without departing from then nature of the present invention.

The seat back 24 is capable of folding flat for shipping prior to introduction into the vehicle. In such a shipping configuration, the energy absorbing link 96 is attached to the bottom frame 28 and unattached to the tower 82, 84; attached to the tower 82, 84 and unattached to the bottom frame 28; or unattached to both the bottom frame 28 and the tower 82, 84. When the seat assembly 20 is installed into the vehicle, the seat back 24 is moved to the upright position and the energy absorbing link 96 is positioned to be attached to both the bottom frame 28 and the respective tower.

The configuration of the seatbelts in combination with the energy absorbing link 96 and towers cooperate to meet the National Highway Transportation Safety Administration's (NHTSA) Federal Motor Vehicle Safety Standards (FMVSS). Generally, the seat 20 is designed to meet the requirements of FMVSS-207 to FMVSS-210, FMVSS-210, FMVSS-213, FMVSS-222, FMVSS-225, and FMVSS-302. It is to be appreciated that the list of FMVSS requirements met is not an exhaustive list and the seat may meet other safety standards.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A seat assembly for a bus, said seat comprising:
a seat bottom;
a seat back pivotally coupled to said seat bottom;
an energy absorbing link extending along a longitudinal axis from said seat bottom to said seat back for controlling pivoting of said seat back relative to said seat bottom;
said energy absorbing link having a first portion connected to said seat bottom, a second portion connected to said seat back, and a deformable portion disposed between said first and second portions wherein pivoting of said seat back relative to said seat bottom moves said first and second portions relative to each other and deforms said deformable portion; and
a first member fixed relative to said first portion and a second member fixed relative to said second portion with said first and second members spaced from each other when said seat back is in an upright position;
said first and second members opposing each other along said longitudinal axis and abutting each other when said first and second portions move toward each other for limiting said deformation of said deformable portion to limit said pivoting of said seat back relative to said seat bottom.

2. The seat assembly as set forth in claim 1 wherein said first member is further defined as a plate attached to said first portion and extending along said longitudinal axis toward said second member.

3. The seat assembly as set forth in claim 2 wherein said second member is further defined as a sleeve attached to said second portion with a pin extending through said sleeve and engaging said seat back for connecting said second portion to said seat back.

4. The seat assembly as set forth in claim 3 wherein said plate defines a cutout receiving said sleeve and abutting said sleeve when said first and second portions move toward each other.

5. The seat assembly as set forth in claim 3 wherein said seat back pivots about a rotational axis and presents an extension spaced from said rotational axis with said pin engaging said extension.

6. The seat assembly as set forth in claim 1 wherein said seat back is rotatable away from said seat bottom from said upright position to a rearward position moving said first and second portions toward each other and deforming said middle portion.

7. The seat assembly as set forth in claim 6 wherein said seat back is rotatable toward said seat bottom from said upright position to a forward position moving said first and second portions away from each other and deforming said middle portion.

8. The seat assembly as set forth in claim 1 wherein said deformable portion includes a kink and wherein said seat back is rotatable away from said seat bottom from said upright position to a rearward position moving said first and second portions toward each other and compressing said kink.

9. The seat assembly as set forth in claim 8 wherein said seat back is rotatable toward said seat bottom from said upright position to a forward position moving said first and second portions away from each other and straightening said kink.

10. The seat assembly as set forth in claim 1 wherein said middle portion plastically deforms when said first and second portions move toward each other.

11. The seat assembly as set forth in claim 1 wherein said first and second portions are rigid relative to said deformable portion.

12. The seat assembly as set forth in claim 1 wherein at least one of said first and second members extend from said first and second portions, respectively.

13. A seat assembly for a bus, said seat assembly comprising:
a seat bottom;
a seat back pivotally coupled to said seat bottom;
an energy absorbing link extending along a longitudinal axis from said seat bottom to said seat back for controlling pivoting of said seat back relative to said seat bottom;
said energy absorbing link having a deformable portion that deforms when said seat back pivots relative to said seat bottom for absorbing energy as said seat back pivots relative to said seat bottom; and
a first member fixed relative to said energy absorbing link and a second member opposing said first member along said longitudinal axis with said first and second members abutting each other when said deformable portion deforms for limiting deformation of said deformable portion to limit pivoting of said seat back relative to said seat bottom.

14. The seat assembly as set forth in claim 13 wherein said seat back is rotatable away from said seat bottom from an upright position to a rearward position deforming said deformable portion.

15. The seat assembly as set forth in claim 14 wherein said first and second members are spaced from each other when said seat back is in said upright position and wherein said first and second members abut when said seat back is in said rearward position.

16. The seat assembly as set forth in claim 14 wherein said seat back is rotatable toward said seat bottom from said upright position to a forward position moving said first deforming said deformable portion.

17. The seat assembly as set forth in claim 13 wherein said first member extends from said energy absorbing link.

18. The seat assembly as set forth in claim 17 wherein said second member is fixed relative to and extends from said energy absorbing link.

19. The seat assembly as set forth in claim 13 wherein said deformable portion plastically deforms when said first and second portions move toward each other.

20. The seat assembly as set forth in claim 13 wherein said deformable portion includes a kink and wherein said seat back is rotatable away from said seat bottom from an upright position to a rearward position compressing said kink.

21. The seat assembly as set forth in claim 20 wherein said seat back is rotatable toward said seat bottom from said upright position to a forward position moving said first straightening said kink.

22. A seat assembly for a bus, said seat assembly comprising:
a frame having at least one support member extending in a horizontal plane;
a seat pan supported by said support member above said horizontal plane for supporting a seated occupant;
a clip extending downwardly from said seat pan and moveable between an engaged position engaging said support member for attaching said seat pan to said support member and a disengaged position disengaged from said support member for selectively removing said seat pan from said frame;
said support member defining a hole in said horizontal plane and said clip extending into said hole transversely to said horizontal plane when said clip is moved toward said engaged position such that the weight of the occupant on said seat pan urges said clip toward said engaged position to ensure attachment of the seat pan to said support member when the occupant is seated on said seat pan.

23. The seat assembly as set forth in claim 22 further comprising a finger extending from said seat pan and engaging said frame to attach said seat pan to said frame.

24. The seat assembly as set forth in claim 23 wherein said clip is moveable to said engaged position only when said finger is engaged with said frame.
